(19) United States
(12) Patent Application Publication
(10) Pub. No.: US 2014/0182547 A1
(43) Pub. Date: Jul. 3, 2014

(54) CONTROL METHOD AND SYSTEM FOR OIL PUMP OF ENGINE PROVIDED WITH VARIABLE VALVE LIFT APPARATUS

(71) Applicant: Hyundai Motor Company, Seoul (KR)

(72) Inventor: Hyoung Hyoun KIM, Hwaseong-city (KR)

(73) Assignee: Hyundai Motor Company, Seoul (KR)

(21) Appl. No.: 14/108,143

(22) Filed: Dec. 16, 2013

(30) Foreign Application Priority Data
Dec. 28, 2012 (KR) 10-2012-0157502

(51) Int. Cl. F02M 39/00

(52) U.S. Cl. CPC F02M 39/005
USPC 123/395; 123/496

(57) ABSTRACT

A method of controlling an oil pump of an engine with a variable valve lift apparatus includes: detecting the operation status of a vehicle; determining whether mode change conditions of a variable valve lift apparatus are satisfied; determining whether the mode change condition of the variable valve lift apparatus is a condition for changing from a low lift to a high lift; comparing whether the current oil hydraulic pressure is larger than the current necessary hydraulic pressure, when the mode change condition of the variable valve lift apparatus is a condition for changing from a low lift to a high lift; and increasing oil pressure by controlling the oil pump, when the current oil hydraulic pressure is not larger than the current necessary hydraulic pressure.

### CROSS-REFERENCE TO RELATED APPLICATION

The present application claims priority of Korean Patent Application Number 10-2012-0157502 filed Dec. 28, 2012, the entire contents of which application is incorporated herein for all purposes by this reference.

### BACKGROUND OF INVENTION

1. Field of Invention

The present invention relates to a method and a system for controlling an oil pump of an engine with a variable valve lift apparatus. More particularly, the present invention relates to a method and a system for controlling an oil pump of an engine with a variable valve lift apparatus.

2. Description of Related Art

Internal combustion engines generate power by receiving and burning air and fuel in a combustion chamber. When air is sucked, an intake valve is operated by a camshaft, and air is sucked into the combustion chamber while the intake valve is open. Further, an exhaust valve is operated by the camshaft, and air is discharged from the combustion chamber while the exhaust valve is open.

The optimum operation of the intake valve/exhaust valve, however, depends on the RPM of the engine. That is, an appropriate time for lifting or valve opening/closing depends on the RPM of the engine. In order to implement an appropriate valve operation in accordance with the RPM of the engine, as described above, a Variable Valve Lift (VVL) apparatus having a plurality of shapes of cam operating valves or operating valves at different lifts in accordance with the RPM of an engine has been studied.

The variable valve lift apparatus varies the valve lift by locking or unlocking the driving unit in accordance with the hydraulic pressure supplied to a lock pin.

When the operation mode of the variable valve lift apparatus changes from a low lift to a high lift, the performance of changing the mode requires relatively high main gallery pressure, which can be improved by increasing the capacity of an oil pump.

When the operation mode of the variable valve lift apparatus changes from a high lift to a low lift, the performance of changing the mode requires relatively low main gallery pressure, which can be improved by decreasing the capacity of an oil pump.

That is, there is a trade-off relationship between when the operation mode of the variable valve lift apparatus changes from a high lift mode to a low lift mode and when the operation mode of the variable valve lift apparatus changes from a low lift mode to a high lift mode.

For a fixing-typed oil pump of which the operation depends on rpm of an engine, there is a limit in improving the performance of a hydraulic variable valve lift apparatus. That is, although it is possible to improve the performance of changing from a low lift mode operation to a high lift mode operation by increasing the capacity of the pump, there is a problem in that the fuel efficiency decreases due to an increase in friction and the performance of changing the modes decreases, when the operation of the variable valve lift apparatus changes from a high lift mode to a low lift mode.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for a method and a system for controlling an oil pump of an engine with a variable valve lift apparatus having advantages of being able to improve performance of changing modes, when changing modes to a high lift mode and a low lift mode, by using a variable oil pump.

Further, the present invention has been made in an effort to provide a method and a system for controlling an oil pump of an engine with a variable valve lift apparatus having advantages of being able to improve performance of changing modes to a high lift mode and a low lift mode without decreasing performance of improving fuel efficiency, even using a variable oil pump.

Various aspects of the present invention provide for method of controlling an oil pump of an engine with a variable valve lift apparatus including: detecting the operation status of a vehicle; determining whether mode change conditions of a variable valve lift apparatus are satisfied; determining whether a mode change condition of the variable valve lift apparatus is a condition for changing from a first lift to a second lift that needs high pressure; comparing whether a current oil hydraulic pressure is higher than a current necessary hydraulic pressure, when the mode change condition of the variable valve lift apparatus is a condition for changing from the first lift to second lift; and increasing oil pressure by controlling the oil pump, when the current oil hydraulic pressure is not higher than the current necessary hydraulic pressure.

The method may further include controlling the operation of the oil pump in accordance with an oil pump control logic inputted in advance, when the current oil hydraulic pressure is higher than the current necessary hydraulic pressure.

The method may further include: comparing whether the current oil hydraulic pressure is higher than allowable hydraulic pressure, when the mode change condition of the variable valve lift apparatus is not the condition for changing from the first lift to the second lift; and decreasing oil pressure by controlling the oil pump, when the current oil hydraulic pressure is higher than the allowable hydraulic pressure.

The method may further include controlling the operation of the oil pump in accordance with an oil pump control logic inputted in advance, when the current oil hydraulic pressure is not higher than the allowable hydraulic pressure.

The operation status may include the position of an accelerator pedal, the speed of a vehicle, the number of revolutions of an engine, the temperature of oil, the pressure of oil, the temperature of a coolant, and the atmospheric temperature.

Various aspects of the present invention provide for a method of controlling an oil pump of an engine with a variable valve lift apparatus including: detecting the operation status of a vehicle; determining whether mode change conditions of a variable valve lift apparatus are satisfied; determining whether a mode change condition of the variable valve lift apparatus is a condition for changing from a first lift to a second lift that needs low pressure; comparing whether the current oil hydraulic pressure is higher than allowable hydraulic pressure, when the mode change condition of the variable valve lift apparatus is the condition for changing from the first lift to the second lift; and decreasing oil pressure by controlling the oil pump, when the current oil hydraulic pressure is higher than the allowable hydraulic pressure.

The method may further include controlling the operation of the oil pump in accordance with an oil pump control logic inputted in advance, when the current oil hydraulic pressure is higher than the current allowable hydraulic pressure.

The method may further include comparing whether a current oil hydraulic pressure is higher than a current necessary hydraulic pressure, when the mode change condition of the variable valve lift apparatus is not a condition for changing from the first lift to second lift; and increasing oil pressure by controlling the oil pump, when the current oil hydraulic pressure is not higher than the current necessary hydraulic pressure.

The method may further include controlling the operation of the oil pump in accordance with an oil pump control logic inputted in advance, when the current oil hydraulic pressure is higher than the current necessary hydraulic pressure.

The operation status may include the position of an accelerator pedal, the speed of a vehicle, the number of revolutions of an engine, the temperature of oil, the pressure of oil, the temperature of a coolant, and the atmospheric temperature.

Various aspects of the present invention provide for a system for controlling an oil pump of an engine with a variable valve lift apparatus including: a plurality of sensors detecting the operation status of a vehicle and outputting corresponding signals; a variable hydraulic pump generating oil pressure; and a control unit controlling the operation of the variable oil pump in response to the signals from the sensors; wherein the control unit performs one of the above mentioned methods.

The sensors may include: an accelerator pedal position sensor measuring the accelerator pedal position and outputting a corresponding signal; a vehicle speed sensor measuring the speed of a vehicle and outputting a corresponding signal; an engine speed sensor measuring the number of revolutions of an engine and outputting a corresponding signal; an oil temperature sensor measuring the temperature of oil and outputting a corresponding signal; an oil pressure sensor measuring the pressure of oil and outputting a corresponding signal; a coolant temperature sensor measuring the temperature of a coolant and outputting a corresponding signal; and an atmosphere temperature sensor measuring the temperature of new air flowing inside and outputting a corresponding signal.

According to various aspects of the present invention, it is possible to mode change performance in mode change between a high lift mode and a low lift mode, by using a variable oil pump.

According to various aspects of the present invention, it is possible to mode change performance in mode change between a high lift mode and a low lift mode without deteriorating the performance of improving fuel efficiency, even using a variable oil pump.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of an exemplary system for controlling an oil pump of an engine with a variable valve lift apparatus according to the present invention.

FIG. 2 is a flowchart illustrating an exemplary method of controlling an oil pump of an engine with a variable valve lift apparatus according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Like reference numerals are given to like components throughout the specification.

Throughout the specification, unless explicitly described to the contrary, the word “comprise” and variations such as “comprises” or “comprising”, will be understood to imply the inclusion of stated elements but not the exclusion of any other elements.

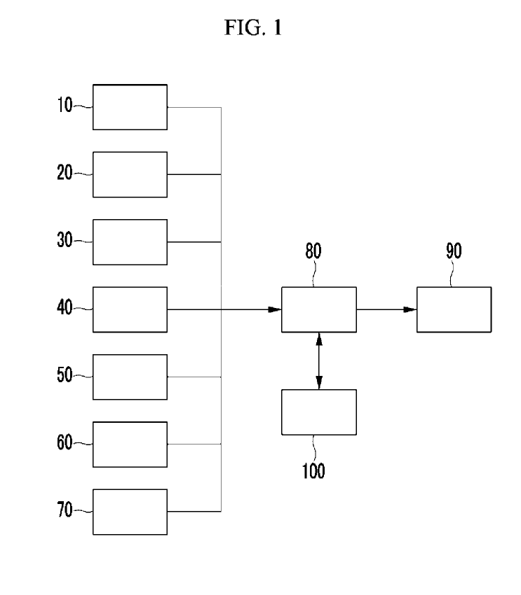

FIG. 1 is a block diagram of a system for controlling an oil pump of an engine with a variable valve lift apparatus according to various embodiments of the present invention.

A system for controlling an oil pump of an engine with a variable valve lift apparatus according to various embodiments of the present invention includes a plurality of sensors that detects the operation status of a vehicle and outputs corresponding signals, a variable oil pump 90 that generates an oil pressure, and a control unit 80 that controls the operation of the variable oil pump 90 in response to the signals from the sensors. The control unit 80 may be an Engine Control Unit (ECU).

The sensors include an accelerator pedal position sensor 10 measuring the accelerator pedal position and outputting a corresponding signal, a vehicle speed sensor 20 measuring the speed of a vehicle and outputting a corresponding signal, an engine speed sensor (or an rmp sensor) 30 measuring the number of revolutions of an engine and outputting a corresponding signal, an oil temperature sensor 40 measuring the temperature of oil and outputting a corresponding signal, an oil pressure sensor 50 measuring the pressure of oil and outputting a corresponding signal, a coolant temperature sensor 60 measuring the temperature of a coolant and outputting a corresponding signal, and an atmosphere temperature sensor 80 measuring the temperature of new air flowing inside and outputting a corresponding signal.

The control unit 80 can perform a series of instructions for controlling the operation of the oil pump 90 and determines the operation mode of the variable valve lift apparatus 100 by determining the operation status of a vehicle which is found by the sensors 10, 20, 30, 40, 50, 60, and 70 and determining the operation status of the variable valve lift apparatus 100.

The variable oil pump 90 has been developed usually to improve fuel efficiency and the control unit 80 decreases the operation of the variable oil pump 90 by performing proportional control on a solenoid, thereby reducing the oil pressure the supply amount of oil, in a fuel efficiency priority section. Further, in a performance or durability priority section, the control unit 80 increases the operation of the variable oil pump 90 by performing proportional control on the solenoid, thereby increasing the oil pressure and the supply amount of oil.

The operation of the variable oil pump 90 is controlled in accordance with a common control logic inputted in advance in the control unit 80. The control logic is determined in advance in accordance with oil-on, the oil pressure, and the number of revolutions of the engine and referred to as an oil pump control logic inputted in advance. The common oil pump control logic is apparent to those skilled in the art and the detailed description is not provided.

A method of controlling a oil pump of an engine with a variable valve lift apparatus according to various embodiments of the present invention controls the operation of the variable oil pump 90 while comparing the oil pressure measured in the current operation mode or in changing modes of the variable valve lift apparatus 100 with a predetermined necessary hydraulic pressure or an allowable hydraulic pressure, independently from the common oil pump control logic.

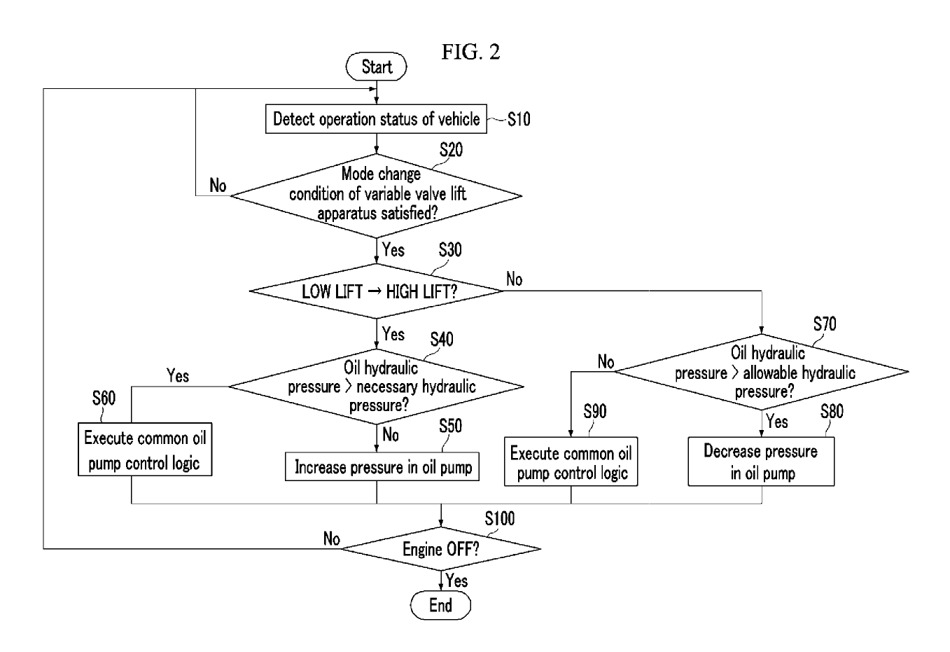

FIG. 2 is a flowchart illustrating a method of controlling an oil pump of an engine with a variable valve lift apparatus according to various embodiments of the present invention.

Hereinafter, a method of controlling an oil pump of an engine with a variable valve lift apparatus according to various embodiments of the present invention is described with reference to FIGS. 1 and 2.

The control unit 80 of the system for controlling an oil pump of an engine with a variable valve lift apparatus according to various embodiments of the present invention detects the operation status of a vehicle (S10) and determines whether mode change conditions of the variable valve lift apparatus 100 are satisfied (S20).

Whether the mode change conditions of the variable valve lift apparatus 100 are satisfied can be determined by applying the signals from the accelerator pedal position sensor 10, the vehicle speed sensor 20, the engine speed sensor (or the rmp sensor) 30, the oil temperature sensor 40, the oil pressure sensor 50, the coolant temperature sensor 60, and the atmosphere temperature sensor 80 to a predetermined map.

The control unit 80 determines whether it is the condition for changing the mode of the variable valve lift apparatus 100 from a low lift to a high lift, when the mode change conditions of the variable valve lift apparatus 100 are satisfied (S30).

The control unit 80 compares whether the current oil hydraulic pressure is larger than the current necessary hydraulic pressure, when the mode change condition of the variable valve lift apparatus 100 is the condition for changing from a low lift to a high lift (S40). The current necessary hydraulic pressure, which is a hydraulic pressure for changing the mode of the variable valve lift apparatus 100 from a low lift to a high lift, may be a minimum mode change hydraulic pressure determined in advance by a test.

The control unit 80 increases the oil pressure by controlling the oil pump 90, when the current oil hydraulic pressure is not larger than the current necessary hydraulic pressure (S50). The control unit 80 may perform feedback control for increasing pressure or may increase the oil pressure of the variable oil pump 90 in accordance with a predetermined map, in the control of increasing the oil pressure of the variable oil pump 90.

The control unit 80 compares whether the current oil hydraulic pressure is larger than the allowable hydraulic pressure, when the mode change condition of the variable valve lift apparatus 100 is not the condition for changing from a low lift to a high lift (S70). The allowable hydraulic pressure, which is a maximum allowable hydraulic pressure where the mode change condition of the variable valve lift apparatus 100 is changed into a low lift mode from a high lift, may be set in advance by a test. The oil pressure for is low lift mode is smaller than the oil pressure for a high lift mode in the variable valve lift apparatus 100, such that the fuel efficiency can be improved by reducing the operation load of the variable oil pump 90.

The control unit 80 decreases the oil pressure by controlling the oil pump 90, when the current oil hydraulic pressure is larger than the allowable hydraulic pressure (S80). The control unit 80 may perform feedback control for decreasing pressure or may decrease the oil pressure of the variable oil pump 90 in accordance with a predetermined map, in the control of decreasing the oil pressure of the variable oil pump 90.

When the current oil hydraulic pressure is larger than the current necessary hydraulic pressure, the control unit 80 controls the operation of the oil pump 90 in accordance with an oil pump control logic inputted in advance (S60), and when the current oil hydraulic pressure is not larger than the allowable hydraulic pressure, the control unit 80 controls the operation of the oil pump 90 in accordance with an oil pump control logic inputted in advance (S90). The control is based on a common control logic inputted in advance in the control unit 80, for controlling the operation of the variable oil pump 90 described above, that is, an independent logic from that in the method of controlling an oil pump of an engine with a variable valve lift apparatus according to various embodiments of the present invention.

The operation status may include the position of an accelerator pedal, the speed of a vehicle, the number of revolutions of an engine, the temperature of oil, the pressure of oil, the temperature of a coolant, and the atmospheric temperature, which were described above.

In various embodiments of the present invention, the method of controlling an oil pump of an engine may be applied to an variable valve lift apparatus of which relatively high pressure is supplied in the high lift mode and relatively low pressure is supplied in the low lift mode, so called as Pressure Lock Type variable valve lift apparatus. However it is not limited thereto.

On the contrary, the method of controlling an oil pump of an engine may be applied to an variable valve lift apparatus of which relatively high pressure is supplied in the low lift mode and relatively low pressure is supplied in the high lift mode, so called as Unpressure Lock Type variable valve lift apparatus.

And the low lift mode described above means a mode which may execute 0 (zero) life mode as well as s relatively small amount valve lift profile.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. A method of controlling an oil pump of an engine with a variable valve lift apparatus, the method comprising:
detecting the operation status of a vehicle;
determining whether mode change conditions of a variable valve lift apparatus are satisfied;
determining whether a mode change condition of the variable valve lift apparatus is a condition for changing from a first lift to a second lift that needs high pressure;
comparing whether a current oil hydraulic pressure is higher than a current necessary hydraulic pressure, when the mode change condition of the variable valve lift apparatus is a condition for changing from the first lift to second lift; and
increasing oil pressure by controlling the oil pump, when the current oil hydraulic pressure is not higher than the current necessary hydraulic pressure.

2. The method of claim 1, further comprising controlling the operation of the oil pump in accordance with an oil pump control logic inputted in advance, when the current oil hydraulic pressure is higher than the current necessary hydraulic pressure.

3. The method of claim 1, further comprising:
comparing whether the current oil hydraulic pressure is higher than allowable hydraulic pressure, when the mode change condition of the variable valve lift apparatus is not the condition for changing from the first lift to the second lift; and
decreasing oil pressure by controlling the oil pump, when the current oil hydraulic pressure is higher than the allowable hydraulic pressure.

4. The method of claim 6, further comprising controlling the operation of the oil pump in accordance with an oil pump control logic inputted in advance, when the current oil hydraulic pressure is not higher than the allowable hydraulic pressure.

5. The method of claim 1, wherein the operation status includes the position of an accelerator pedal, the speed of a vehicle, the number of revolutions of an engine, the temperature of oil, the pressure of oil, the temperature of a coolant, and the atmospheric temperature.

6. A method of controlling an oil pump of an engine with a variable valve lift apparatus, the method comprising:
detecting the operation status of a vehicle;
determining whether mode change conditions of a variable valve lift apparatus are satisfied;
determining whether a mode change condition of the variable valve lift apparatus is a condition for changing from a first lift to a second lift that needs low pressure;
comparing whether the current oil hydraulic pressure is higher than allowable hydraulic pressure, when the mode change condition of the variable valve lift apparatus is the condition for changing from the first lift to the second lift; and
decreasing oil pressure by controlling the oil pump, when the current oil hydraulic pressure is higher than the allowable hydraulic pressure.

7. The method of claim 6, further comprising controlling the operation of the oil pump in accordance with an oil pump control logic inputted in advance, when the current oil hydraulic pressure is higher than the current allowable hydraulic pressure.

8. The method of claim 6, further comprising comparing whether a current oil hydraulic pressure is higher than a current necessary hydraulic pressure, when the mode change condition of the variable valve lift apparatus is not a condition for changing from the first lift to second lift; and
increasing oil pressure by controlling the oil pump, when the current oil hydraulic pressure is not higher than the current necessary hydraulic pressure.

9. The method of claim 8, further comprising controlling the operation of the oil pump in accordance with an oil pump control logic inputted in advance, when the current oil hydraulic pressure is higher than the current necessary hydraulic pressure.

10. The method of claim 6, wherein the operation status includes the position of an accelerator pedal, the speed of a vehicle, the number of revolutions of an engine, the temperature of oil, the pressure of oil, the temperature of a coolant, and the atmospheric temperature.

11. A system for controlling an oil pump of an engine with a variable valve lift apparatus, the system comprising:
a plurality of sensors detecting the operation status of a vehicle and outputting corresponding signals;
a variable hydraulic pump generating oil pressure; and
a control unit controlling the operation of the variable oil pump in response to the signals from the sensors;
wherein the control unit performs the method of claim 1.

12. The system of claim 11, wherein the sensors include:
an accelerator pedal position sensor measuring the accelerator pedal position and outputting a corresponding signal;
a vehicle speed sensor measuring the speed of a vehicle and outputting a corresponding signal;
an engine speed sensor measuring the number of revolutions of an engine and outputting a corresponding signal;
an oil temperature sensor measuring the temperature of oil and outputting a corresponding signal;
an oil pressure sensor measuring the pressure of oil and outputting a corresponding signal;
a coolant temperature sensor measuring the temperature of a coolant and outputting a corresponding signal; and
an atmosphere temperature sensor measuring the temperature of new air flowing inside and outputting a corresponding signal.
